(19) United States
(12) Patent Application Publication
(10) Pub. No.: US 2007/0046023 A1
(43) Pub. Date: Mar. 1, 2007

(54) Connecting structure of water transfer pipeline

(76) Inventor: Den-Lu Hung, Sanchung (TW)

Correspondence Address: TROXELL LAW OFFICE PLLC;SUITE 1404, 5205 LEeSBURG PIKE, FALLS CHURCH, VA, 22041, US

(21) Appl. No.: 11/506,796

(22) Filed: Aug. 21, 2006

(30) Foreign Application Priority Data
Aug. 24, 2005 (TW) 094214560

(51) Int. Cl. F16L 27/04

(52) U.S. Cl. 285/261

(57) ABSTRACT

A connecting structure of water transfer pipeline, including a connecting member having a central flow way, a ball section at one end and an insertion end at the other end. An outer collar is fitted around the insertion end. An inner circumference of the outer collar is formed with an annular groove in which a C-shaped retainer ring is inlaid. The retainer ring abuts against an annular rib of the connecting member. A water pipe is fitted around the insertion end of the connecting member to clamp the C-shaped retainer ring, whereby the connecting member, the outer collar and the water pipe are connected with each other. A ball seat formed with a central passage and having a tapered lower opening is fitted around the ball section of the connecting member. An upper opening of the ball seat is formed with an inner thread. An upper retainer collar is fitted around the other side of the ball section. A water transfer pipe with outer thread is screwed in the inner thread of the ball seat. The water transfer pipe compresses the upper retainer ring, whereby the ball section of the connecting seat is pivotally embraced by the ball seat.

### BACKGROUND OF THE INVENTION

The present invention is related to a connecting structure of water transfer pipeline. By means of the connecting structure, a water transfer pipe can be freely pivoted relative to the water pipe. This facilitates the use of the water transfer pipe.

FIG. 1 shows a connecting structure for connecting a water transfer pipe and a water pipeline such as a sprinkler and a water pipe. A retainer collar 401 is fitted around the outlet end of the water pipe 4. The retainer ring 401 is formed with an outer flange 402. A tubular connecting seat 6 is fitted around the retainer ring 401. The connecting seat 6 has an inner flange 61 at one end for abutting against the outer flange 402. The other end of the connecting seat 6 is formed with inner thread 62. An O-ring 63 is placed between the sprinkler 5 (or another water transfer pipe) and the retainer collar 401. Then the connecting seat 6 is screwed on the outer thread 51 of the sprinkler 5. The O-ring 63 is compressed between the sprinkler 5 and the connecting seat 6 to avoid leakage. In the above structure, the sprinkler 5 is screwed with the water pipe 4 and cannot be bent or deflected. The water pipe 4 has a limited length. In addition, the other end of the water pipe 4 is connected with a water source pipeline. Therefore, the use and position of the sprinkler 5 are limited.

### SUMMARY OF THE INVENTION

It is therefore a primary object of the present invention to provide a connecting structure of water transfer pipeline, including a connecting member, an outer collar and a ball seat. The connecting member is formed with a central flow way. An annular rib is formed on outer circumference of a middle section of the connecting member. One end of the connecting member is formed with a ball section, while the other end of the connecting member is an insertion end. The outer collar is fitted around the insertion end. An inner circumference of a middle section of the outer collar is formed with an annular groove in which a C-shaped retainer ring is inlaid. One face of the retainer ring abuts against the annular rib of the connecting member. A water pipe is fitted around the insertion end of the connecting member to clamp the C-shaped retainer ring, whereby the connecting member, the outer collar and the water pipe are connected with each other. The ball seat is formed with a central passage and has a tapered lower opening is fitted around the ball section of the connecting member. An upper opening of the ball seat is formed with an inner thread. An upper retainer collar is fitted around the other side of the ball section. A water transfer pipe with outer thread is screwed in the inner thread of the ball seat. The water transfer pipe compresses the upper retainer ring, whereby the ball section of the connecting seat is pivotally embraced by the ball seat. Accordingly, the water transfer pipe can be freely pivoted relative to the water pipe. This facilitates the use of the water transfer pipe.

The present invention can be best understood through the following description and accompanying drawings wherein:

### BRIEF DESCRIPTION OF THE DRAWINGS

FIG. 1 is a sectional view of a conventional connecting structure for connecting a sprinkler (water transfer pipe) with a water pipe;

FIG. 2 is a perspective exploded view of the present invention;

FIG. 3 is a perspective assembled view of the present invention;

FIG. 4 is a sectional assembled view of the present invention;

FIG. 5 is a sectional assembled view of the present invention according to FIG. 4, in which the sprinkler is pivoted;

FIG. 6 is a perspective view of the present invention, in which the sprinkler is pivoted in one state; and

FIG. 7 is a perspective view of the present invention, in which the sprinkler is pivoted in another state.

### DETAILED DESCRIPTION OF THE PREFERRED EMBODIMENTS

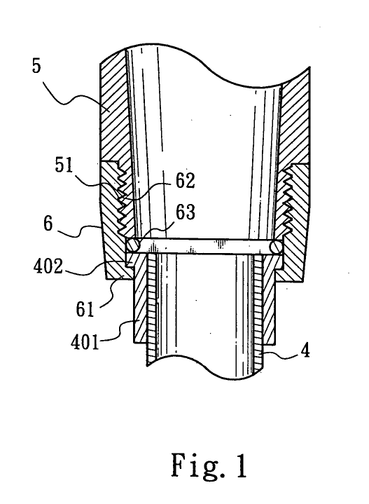

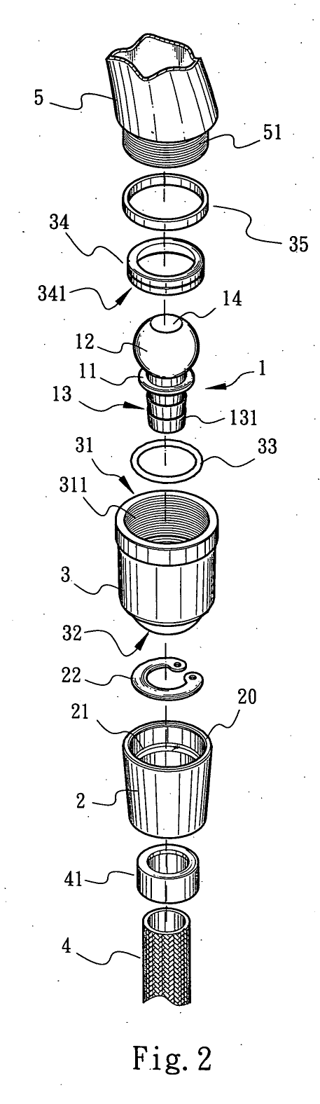

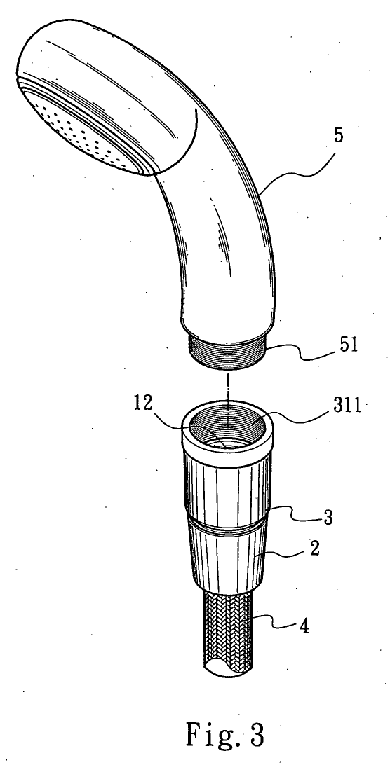

Please refer to FIGS. 1 to 3. The present invention includes a connecting member 1, an outer collar 2 and a ball seat 3. The connecting member 1 is formed with a central flow way 14. An annular rib 11 is formed on outer circumference of a middle section of the connecting member 1. One end of the connecting member 1 is formed with a ball section 12, while the other end of the connecting member 1 is an insertion end 13. The outer circumference of the insertion end 13 is formed with multiple tapered check flanges 131. The outer collar 2 is fitted around the insertion end 13. A front section of the outer collar 2 is formed with a contact opening 201. An inner circumference of a middle section of the outer collar 2 is formed with an annular groove 21 in which a C-shaped retainer ring 22 is inlaid. One face of the retainer ring 22 abuts against the annular rib 11 of the connecting member 1. A water pipe 4 with a lower retainer collar 41 is fitted in a rear end of the outer collar 2 around the insertion end 13 of the connecting member 1. The check flanges 131 serve to prevent the water pipe 4 from detaching from the insertion end 13. The retainer ring 22 is clamped between the lower retainer collar 41 and the annular rib 11, whereby the connecting member 1 and the outer collar 2 are connected with the water pipe 4. The ball seat 3 is formed with a central passage and has an upper opening 31. An inner circumference of the upper opening 31 is formed with an inner thread 311. The inner circumference 321 and outer circumference 322 of a lower opening 32 of the ball seat 3 are both spherical faces. The lower end of the ball seat 3 is fitted around the ball section 12 of the connecting member 1 with an O-ring 33 positioned between the inner circumference 321 and the ball section 12. The contact opening 20 abuts against the outer circumference 322. An upper retainer collar 34 having an expanded opening 341 is fitted around the other side of the ball section 12. A fastening ring 35 can be padded on the upper retainer collar 34 as necessary. A water transfer pipe 5 with outer thread 51 is screwed in the inner thread 311 of the ball seat 3. The water transfer pipe 5 and the upper retainer ring 34 compress the fastening ring 35, whereby the ball section 12 of the connecting seat 1 is embraced by the ball seat 3.

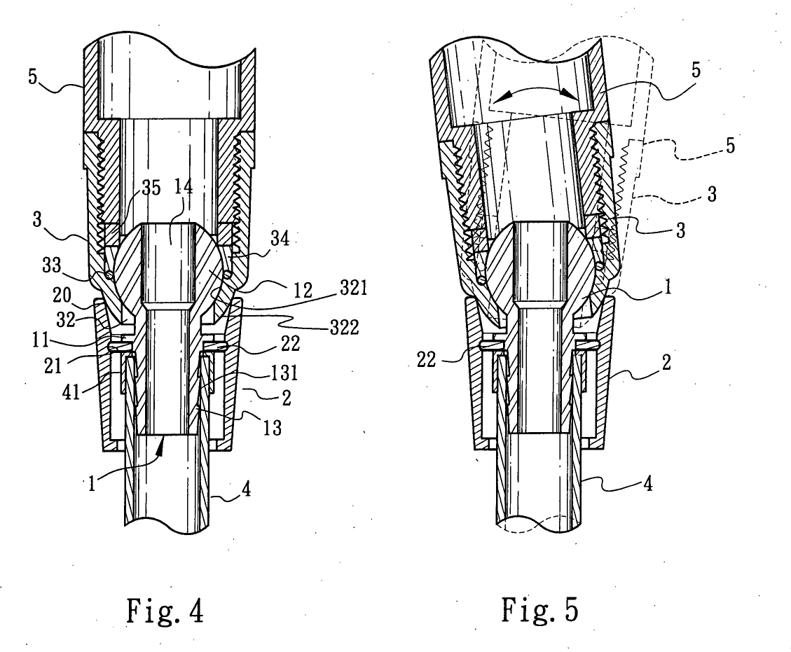

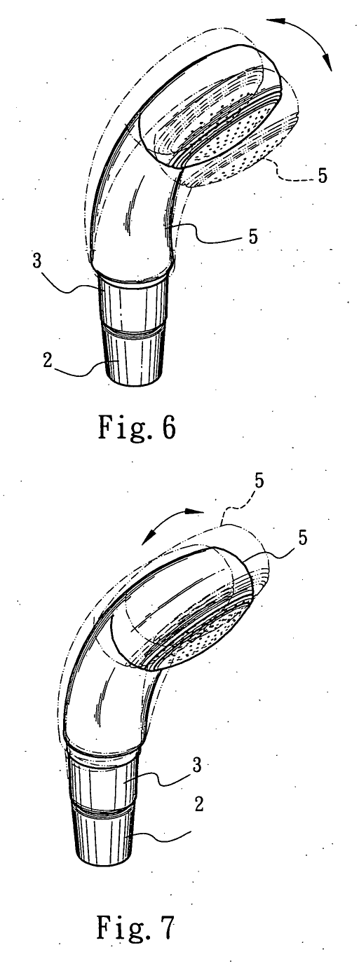

Referring to FIGS. 4 to 7, the water pipe 4 is embraced by the lower retainer ring 41 and prevented from detaching from the insertion end 13 by the check flanges 131. Therefore, the water pipe 4 is firmly fitted around the insertion end 13 of the connecting member 1. The water flows from the water pipe 4 into the flow way 14 of the connecting member 1 without leaking out. When the water flows out from the ball section 12, the O-ring 33 compressed between the lower opening 32 of the ball seat 3 and the ball end 12 serves to prevent the water from leaking out. In addition, two sides of the ball section 12 are respectively embraced by the gradually contracted lower opening 32 of the ball seat 3 and the expanded opening 341 of the upper retainer ring 34. By means of the ball section 12, the water transfer pipe 5 can be freely pivotally rotated as shown in FIG. 5. Accordingly, the water transfer pipe 5 can be freely deflected relative to the water pipe 4 as shown in FIGS. 6 and 7. This makes it more convenient to use the water transfer pipe 5.

The above embodiments are only used to illustrate the present invention, not intended to limit the scope thereof. Many modifications of the above embodiments can be made without departing from the spirit of the present invention.

What is claimed is:

1. A connecting structure of water transfer pipeline, comprising:
a connecting member formed with a central flow way, one end of the connecting member being formed with a ball section, while the other end of the connecting member being an insertion end;
an outer collar fitted around the insertion end, a front section of the outer collar being formed with a contact opening, the contact opening via a water pipe being fitted around the insertion end of the connecting member, whereby the connecting member, the outer collar and the water pipe are connected with each other; and
a ball seat formed with a central passage and having an upper opening at one end for connecting with a water transfer pipe, the ball seat further having a lower opening at the other end, an inner circumference and an outer circumference of the lower opening of the ball seat being both spherical faces, the lower end of the ball seat being fitted around the ball section of the connecting member, the contact opening abutting against the outer circumference of the lower end of the ball seat, whereby the ball seat embraces the ball section of the connecting member to connect the ball seat with the connecting member.

2. The connecting structure of water transfer pipeline as claimed in claim 1, wherein an inner circumference of a middle section of the outer collar is formed with an annular groove in which a C-shaped retainer ring is inlaid, one face of the retainer ring abutting against an annular rib of the connecting member.

3. The connecting structure of water transfer pipeline as claimed in claim 1, wherein an upper retainer collar is disposed in the ball seat and fitted around the other side of the ball section, a water transfer pipe with outer thread being screwed in an inner thread of the ball seat, whereby the water transfer pipe compresses the upper retainer ring.

4. The connecting structure of water transfer pipeline as claimed in claim 2, wherein an upper retainer collar is disposed in the ball seat and fitted around the other side of the ball section, a water transfer pipe with outer thread being screwed in an inner thread of the ball seat, whereby the water transfer pipe compresses the upper retainer ring.

5. The connecting structure of water transfer pipeline as claimed in claim 1, wherein an O-ring is positioned between the inner circumference of the lower opening of the ball seat and the ball section of the connecting member for avoiding leakage of the water.

6. The connecting structure of water transfer pipeline as claimed in claim 3, wherein a fastening ring is compressed between one end of the water transfer pipe and the upper retainer ring.

7. The connecting structure of water transfer pipeline as claimed in claim 1, wherein an outer circumference of the insertion end of the connecting member is formed with multiple tapered check flanges for preventing the water pipe from detaching from the insertion end.

8. The connecting structure of water transfer pipeline as claimed in claim 2, wherein an outer circumference of the insertion end of the connecting member is formed with multiple tapered check flanges for preventing the water pipe from detaching from the insertion end.

9. The connecting structure of water transfer pipeline as claimed in claim 3, wherein an outer circumference of the insertion end of the connecting member is formed with multiple tapered check flanges for preventing the water pipe from detaching from the insertion end.

10. The connecting structure of water transfer pipeline as claimed in claim 5, wherein an outer circumference of the insertion end of the connecting member is formed with multiple tapered check flanges for preventing the water pipe from detaching from the insertion end.

11. The connecting structure of water transfer pipeline as claimed in claim 1, wherein a lower retainer ring is fitted around one end of the water pipe for avoiding over-expansion and deformation of the water pipe.

12. The connecting structure of water transfer pipeline as claimed in claim 2, wherein a lower retainer ring is fitted around one end of the water pipe for avoiding over-expansion and deformation of the water pipe.

13. The connecting structure of water transfer pipeline as claimed in claim 3, wherein a lower retainer ring is fitted around one end of the water pipe for avoiding over-expansion and deformation of the water pipe.

14. The connecting structure of water transfer pipeline as claimed in claim 5, wherein a lower retainer ring is fitted around one end of the water pipe for avoiding over-expansion and deformation of the water pipe.

15. The connecting structure of water transfer pipeline as claimed in claim 7, wherein a lower retainer ring is fitted around one end of the water pipe for avoiding over-expansion and deformation of the water pipe.

16. The connecting structure of water transfer pipeline as claimed in claim 11, wherein a lower retainer ring is fitted around one end of the water pipe for avoiding over-expansion and deformation of the water pipe.

17. The connecting structure of water transfer pipeline as claimed in claim 1, wherein the water transfer pipe is a sprinkler.

18. The connecting structure of water transfer pipeline as claimed in claim 2, wherein the water transfer pipe is a sprinkler.

19. The connecting structure of water transfer pipeline as claimed in claim 3, wherein the water transfer pipe is a sprinkler.
